(19) United States
(12) Patent Application Publication
(10) Pub. No.: US 2009/0297845 A1
(43) Pub. Date: Dec. 3, 2009

(54) Safety element with fluorescent characteristics

(76) Inventors: Johann Hilburger, Pirk (DE); Karl Lippe, Weiden (DE)

Correspondence Address: WENDEROTH, LIND & PONACK, L.L.P., 1030 15th Street, N.W.,, Suite 400 East, Washington, DC, 20005-1503, US

(21) Appl. No.: 12/385,860

(22) Filed: Apr. 22, 2009

(30) Foreign Application Priority Data
Apr. 22, 2008 (EP) 08 007 728.2

(51) Int. Cl. B32B 27/00

(52) U.S. Cl. 428/354; 428/421

(57) ABSTRACT

A safety element consisting of a transparent carrier substrate, wherein the carrier substrate is coated on both outer surfaces with different fluorescent dyes, whereby the carrier substrate is impermeable to light of a wave length of less than 400 nm through addition of UV-absorbent additives, or where on the outer surface of the carrier substrate, a coat of paint is applied on the fluorescent coating present under this outer surface, which is impermeable to light of a wave length of less than 400 nm.

The invention discloses a transparent safety element with different fluorescent characteristics on both sides.

Safety elements with fluorescent characteristics are known.

So, for example, in EP-A 330 733, safety elements, especially safety threads are described, that consist of a light-transmissive plastic foil, an opaque coat that covers the entire safety element, which has gaps in the form of encryption to be placed, especially in the from of markings and patterns. At least in the unfrozen areas created by the gaps, congruent, chromophoric and/or luminescent substrates can be present, through which, with corresponding light influence, the encryption differentiates itself in coloured contrasts,

When a transparent carrier substrate is coated on both sides with different fluorescent dyes, it leads to a subtractive colour combination of the two different dyes, thus giving the same colour impression when seen from both sides.

Function of the invention is to prepare a transparent safety element that is coated on both sides with different fluorescent dyes, whereby these dyes are noticeable individually from both sides.

Object of the invention is therefore a safety element consisting of a transparent carrier substrate, wherein the carrier substrate is coated on both outer surfaces with different fluorescent dyes, whereby the carrier substrate is impermeable to light of a wave length of less than 400 nm through addition of UV-absorbent additives, or where on the outer surface of the carrier substrate, a coat of paint is applied on the fluorescent coating present under this outer surface, which is impermeable to light of a wave length of less than 400 nm.

As carrier substrates for example one can think of transparent, flexible plastic foils such as those made of PL, PP, OPP, PE, PPS, PEEK, PEK, PEI, PAEK, LCP, PEN, PBT, PET, PA, PC, COC, POM, ABS, PVC, PTFE, fluoro-polymers such as Teflon, PVB, etc.

The carrier foils should preferably have a thickness of 5-700 μm, or better 5-200 μm or best 5-60 μm.

The carrier substrate is attached to an outer surface that is coated with a paint that is impermeable to light with a wave length of less than 400 nm.

The paint can consist of a bonding agent that is selected based on the substrate, for e.g. Nitrocellulose, PVC, Acrylate, etc., as well as an UV-absorbent additive. As UV-absorbent additives one can consider for e.g. Phosphites, Triazin, Benzotriazols, ether-inhibited Amines, e.g. Tinuvin by Ciba, Chisorb from Double Bond, etc.

The paint can be applied on the complete or partial surface in a conventional printing process for e.g. deep, flexo-graphic, screen, inkjet or digital print, through curtain coating, roller application, painting and spraying, etc.

Alternatively, even a carrier foil can be used as a carrier substrate, which through addition of UV-absorbent additives, is impermeable to light with a wave length of less than 400 nm.

On this coat of paint and/or the UV-light impermeable carrier substrate, a coat of fluorescent paint or fluorescent dye is applied.

The paint can be applied in a conventional printing process for e.g. deep, flexo-graphic, screen, inkjet or digital print, through curtain coating, roller application, painting and spraying, etc.

The fluorescent coating can be applied on the complete surface or partially, in the form of patterns, symbols, guilloche patterns, lines, marks, letters or chain of letters, etc.

Different fluorescent dyes can also be applied one after the other, whereby these different fluorescent dyes can create for e.g. a so-called rainbow or other pattern.

On the other surface of the carrier substrate, a coat with a fluorescent paint or fluorescent colour is applied, whereby this coating is different to the coating present on the paint layer and/or on the other side of the carrier substrate.

This coat can be applied on the complete or partial surface in a conventional printing process for e.g. deep, flexo-graphic, screen, inkjet or digital print.

The fluorescent coating can also be applied on the complete surface or partially, in the form of patterns, symbols, guilloche patterns, lines, marks, letters or chain of letters, etc.

Different fluorescent dyes can also be applied one after the other, whereby these different fluorescent dyes can create for e.g. a so-called rainbow or other pattern, whereby these patterns are different to the patterns on the coat of paint on the other outer surface of the carrier substrate.

The patterns or partial coats can be applied as accurately covering, displaced or overlapping to one another.

Through the coating present on the outer surface of the carrier substrate, with a paint that is impermeable to light of a wave length under 400 nm, the fluorescent coating can be seen under UV-light from both sides, in its respective, colour, colour sequence and respective pattern, distinctly.

The carrier substrate can also have further functional coats or further functional coats can be applied on the fluorescent coatings.

Thus for example, electrical, conductive layers can be present on the substrate, or be applied, such as electrically conductive polymer coats or conductive colour and paint coats.

In order to adjust the electrical properties, one can add the following to the colour or paint to be applied, for e.g. graphite, rust, conductive organic or inorganic polymers, metal pigments (e.g. copper, aluminum, silver, gold, iron, chrome, etc.), metal alloys such as copper-zinc or copper-aluminum or even amorphous or crystalline ceramic pigments such as ITO, ATO, FTO, etc. In addition, doped or non-doped semiconductors, such as silicium, germanium or doped or non-doped polymer semiconductors, or ion conductors such as amorphous or crystalline metal oxides or metal sulfides, can be used as additives. Furthermore, in order to adjust the electrical properties of the coat, polar or partially polar bonds such as Tenside, or non-polar bonds such as silicon additives or hygroscopic or non-hygroscopic salts can be used or added to the paint.

A metal layer covering the complete or partial surface can be applied as a layer with electrical properties, whereby the partial application is done by means of an etching process (applying a complete surface metal layer and finally a partial removal through etching) or by means of a de-metallization process.

When using a de-metallization process, as a first step, preferably a dye soluble in a solvent (if needed in form of an inverse encryption) is applied, and finally after activation of the carrier substrate through a plasma or corona treatment, the metallic layer is applied, whereby the soluble dye layer, together with the metallization present in these areas, is dissolved with a suitable solvent.

In addition, an electrically conductive polymer layer can be applied as the electrically conductive layer. The electrically conductive polymers can be for e.g. polyaniline or polyethylenedioxythiopene. Preferably PEDT/TS is used as the electrically conductive polymer.

It is also possible to add for e.g. rust or graphite to the magnet dyes used, whereby a magnetic as well as an electric layer, in defined encryption, is produced as per the process of the invention.

Moreover, other safety elements can be considered, such as outer surface relief patterns, e.g. grating, holograms, etc. whereby these patterns can also be metalized or partially metalized if needed.

The optically active patterns are thereby placed in a paint that can be hardened through radiation by means of a forming die or an embossing roller or an embossing die.

The paint that can be hardened through radiation, can be a paint system based on a polyester, epoxy or polyurethane system that contains one or more of the different photo initiators the experts are presently familiar with, which can initiate a hardening of the paint system in varying degrees with the use of varying wave lengths. Thus for example, one photo initiator can be activated with a wave length of 200 to 400 nm and the second one with a wave length of 370 to 600 nm. Between the two activating wave lengths of the different photo initiators, sufficient differential should be maintained, so that, when the first photo initiator is activated, it does not lead to a very strong activation of the second. The area in which the second photo initiator is activated should lie in the transmission wave length area of the carrier substrate used. Electron radiation can be used for the main hardening (activation of the second photo initiators).

As paint that can be hardened by radiation, one can also use water-dilutable paint. Preferably paint systems with polyester base.

In addition, the safety element as per the invention can have, on one or both sides, a hot or cold stamp adhesive, or a self-adhesive coating for application on or for embedding in a substrate, which can be pigmented if needed.

The safety elements as per the invention can, with corresponding packaging (for e.g. threads, bands, strips, patches or other formats) be used as safety features in data carriers, especially valuable documents such as passports, cards, bank notes or labels, seals, etc. as also in packaging material for sensitive goods such as pharmaceuticals, cosmetics, data carriers, electronic components, etc.

1. A safety element consisting essentially of a transparent carrier substrate, wherein the carrier substrate is coated on both outer surfaces with different fluorescent dyes, whereby the carrier substrate is impermeable to light of a wave length of less than 400 nm through addition of UV-absorbent additives, or where on the outer surface of the carrier substrate, a coat of paint is applied on the fluorescent coating present under this outer surface, which is impermeable to light of a wave length of less than 400 nm.

2. Safety element according to claim 1, wherein the paint consists essentially of a bonding agent for e.g. Nitrocellulose, PVC, Acrylate, etc., as well as an UV-absorbent additive, such as Phosphites, Triazine, Benzotriazols, or ether-inhibited Amines.

3. Safety element according to claim 1, wherein the fluorescent coating can be applied either on the complete surface or partially.

4. Safety element according to claim 3, wherein the partial coating is present in the form of patterns, symbols, guilloche patterns, lines, marks, letters or chain of letters etc.

5. Safety element according to claim 3, wherein the partial coatings can be applied as accurately covering, displaced or overlapping to one another.

6. Safety element according to claim 3, wherein the partial coatings can be applied as accurately covering, displaced or overlapping to the partial coating with paint.

7. Safety element according to claim 1, wherein coats with electrically conductive or magnetic or optically active properties are applied on one or both outer surfaces of the carrier substrate.

8. Safety element according to claim 1, wherein one or both sides have a hot or cold stamp adhesive or a self-adhesive coat.

9. Application of the safety element according to claim 1 as safety features in data carriers, especially valuable documents such as passports, cards, bank notes, or labels, seals, etc. as also in packaging materials for sensitive goods such as pharmaceuticals, cosmetics, data carriers, electronic components.
